(19) United States
(12) Patent Application Publication
(10) Pub. No.: US 2026/0256161 A1
(43) Pub. Date: Sep. 3, 2026

(54) ACID COAGULATED SPREADABLE FRESH CHEESE AND RELATIVE PRODUCTION METHOD

(71) Applicant: Iffco Italia S.R.L., Milano (MI) (IT)

(72) Inventors: Francesco Parisi, Milano (MI) (IT); Ilaria Ventimiglia, Milano (MI) (IT); Gaetano Ricciardiello, Milano (MI) (IT)

(21) Appl. No.: 18/879,806

(22) PCT Filed: Jun. 27, 2023
(86) PCT No.: PCT/IB2023/056618

§ 371 Date: Dec. 30, 2024

(30) Foreign Application Priority Data
Jun. 29, 2022 (IT) 102022000013774

(51) Int. Cl. A23C 19/028; A23C 19/032; A23C 19/076; A23C 19/09; B65D 83/141; B65D 83/30

(52) U.S. Cl. CPC A23C 19/028; A23C 19/0323; A23C 19/0765; A23C 19/0925; B65D 83/141; B65D 83/30; A23C 2270/10

(57) ABSTRACT

The present invention relates to an acid coagulated spreadable fresh cheese characterised in that it has:—a acidified milk base particle matrix;—a dry residue comprised between 33% and 47% by weight; and—a moisture content comprised between 53% and 67% by weight. The dry residue consists of:—between 18% and 40% by weight of fats;—between 2% and 2.5% by weight of proteins;—optionally up to 15% by weight of water-soluble natural fibres;—between 0.10 and 0.50% by weight of salt;—optionally between 0.1 and 0.3% by weight of natural flavours and/or natural colorants; and—for the remainder of carbohydrates; being without stabilisers and/or texturisers. Said cheese has a pH comprised between 4 and 5.2. Said cheese is packaged in an aerosol container together with at least one propellant gas, and preferably together with a gas mixture. Said cheese is in liquid form at room temperature in said aerosol container and—at the time of dispensing from said aerosol container—it is in form of a whipped product having an aerated, still and spreadable structure free of syneresis when used immediately.

### FIELD OF THE INVENTION

Forming an object of the present invention is an acid coagulated spreadable fresh cheese and the relative production method.

The spreadable fresh cheese according to the invention may be natural and/or variously flavoured.

Advantageously, the cheese according to the present invention maintains its nutritional properties because whey was maintained in the recipe contrary to what happens in the standard process flow of spreadable cheese. Such whey component notoriously contains important substances from a functional, nutritional and health point of view.

Furthermore, the recovery of whey will lead to obtaining an eco-sustainable product, avoiding the disposal thereof.

With respect to the spreadable product currently available on the market, the cheese according to the present invention, packaged in aerosol containers, ensures greater shelf-life without using preservatives.

The application of the aerosol technology allows to obtain a consistency of the product which would otherwise not occur with the recovery of serum in the finished product without using stabilisers.

The aerosol containers allow to use the product multiple times until the end of primary shelf-life deadline (i.e., consumption within 4 months) guaranteed by hermiticity.

Lastly, the aerosol packaging technology, avoids indicating the secondary shelf-life of the product (i.e., “to be consumed within one week from date opening, once opened”) and it allows to consume the product still fresh, therefore maintaining the characteristics thereof optimal.

### State of the Art

In the dairy-cheese-making industry, the process for producing acid coagulated spreadable fresh cheese provides for various steps. The process starts by mixing cow milk with cream, after which the liquid is pasteurised and cooled. A second step provides for incorporating lactic ferments which serve to provide acidification, organoleptic and gustatory structure, and protein coagulation to the product. Once salted, the cheese is heated to isolate casein e and whey proteins. Curd and whey protein are separated using centrifuges and, lastly, the solid mass is mixed, modelled and packaged.

The main drawbacks of the prior art technology, provide for discarding whey to obtain the cheese.

The disposal and recovery procedure are expensive and not eco-sustainable.

Furthermore, such waste product has known functional, nutritional and health properties.

The milk whey proteins actually have a high biological, functional, and nutritional value. The main ones are a-lactalbumin, serum albumin, B-lactoglobulin, lactoferrin, immunoglobulins and glycomacropeptides (Marella, 2009; Magarò, 2012). β-lactoglobulin (50-55%), is a good source of branched amino acids and it has the ability to bind the fat-soluble vitamins (A and E), the fatty acids and the minerals such as zinc and calcium, making them more available for the organism (Marella, 2009; Magarò, 2012). α-lactalbumin (20-25%) is rich in tryptophan and it is very important for lactose biosynthesis in the mammary glands, contains 6% of tryptophan, 5% of cysteine and 0.9% methionine (Heine et al., 1990). It is a source of branched amino acids and it has anti-tumour and antimicrobial properties, it is used in infant food formulations because it is the most abundant protein in human milk and increases the production of serotonin in the brain improving mood (Marella, 2009; Magarò, 2012). Serum albumin (5-10%) is a large globular protein formed by 582 amino acids capable of, in vivo, capturing fatty acids to produce glutathione (high cysteine-content), therefore it is a source of branched amino acids. It is also used against infections due to its antioxidant properties and in nutritional formulations (Marella, 2009; Magarò, 2012). Immunoglobulins (10-15%) are formed by IgM and IgA; are the most abundant proteins in colostrum: they are glycoproteins formed by two light and by two heavy chains (Marella, 2009; Magarò, 2012). Lactoferrin LF (0.5%) is bound to glycoproteins (family of transferrin, with the ability to bind iron which—if free—could lead to the formation of radicals), is a potent antimicrobial, antibacterial and anti-inflammatory agent. It is also used in nutritional formulations. (Marella, 2009; Magarò, 2012). Lactoperoxidase LP (0.2%) is produced by epithelial cells. It is an enzyme and a glycoprotein with antimicrobial action. It is used as a stabilising agent in yoghurt and in the pharmaceutical industry (Marella, 2009; Magarò, 2012). Glycomacropeptide (GMP) is a small protein with a very small mass; it is formed by k-casein which comes from casein micelles and is removed through filtration membrane. After filtration, the product is light-coloured, homogeneous, and odourless (AbdEl-Salam, 1996; Marella, 2009; Magarò, 2012). Therefore, over the last 20 years, whey has gone from being a waste product to a product with high added value (Krissansen, 2007; Haug, 2007).

Therefore, in the food industry there is strongly felt the need for reducing production waste to the minimum and the relative management thereof, as well as enhancing the nutritional and organoleptic properties of the whey protein.

As disclosed by the U.S. Pat. No. 7,897,185B1 there has already been studied a spreadable cheese model which includes—in the recipe—starting whey, with the advantages that it can lead to the main organoleptic and functional characteristics of the product as well as the already known advantages of a process in which there can be reutilised the ones that otherwise would be production waste.

The product obtained according to U.S. Pat. No. 7,897,185B1 generally has the appearance and consistency of a spreadable cheese, it includes milk whey which significantly broadens the taste of the product, conferring a considerably superior and strong taste. Maintaining whey in the recipe allows to obtain a natural flavour without subjecting the product to excessive addition of additives during processing, and it has a significant economic and environmental impact on the production process with respect to the standard process.

Maintaining whey in the recipe in a standard technological process inevitably leads to decreasing the dry residue and increase free water in the product. Therefore, the patent mentioned above however provides for adding stabilisers to the recipe. Therefore, stabilisers have the function of thickening the product binding with excess water which causes syneresis.

U.S. Pat. No. 7,897,185 B1 therefore described a product which—by type and desired characteristics—cannot avoid the use of stabilisers and other additives.

In order to avoid syneresis (release of the aqueous phase from the coagulation), an unappealing phenomenon for the consumer and highly likely in a product containing much more free water than a standard spreadable product which did not maintain whey in the recipe, U.S. Pat. No. 7,897,185B1 necessarily provides for the use of additives (such as gums, emulsifiers, salts) so as to obtain “consistency” sufficient to attain viscosity comprised between 1,500,000 cps and 5,000,000 cps. Furthermore, U.S. Pat. No. 7,897185B1 suggests improving the spreadability and therefore the yield of the product, whose texture would otherwise be too hard, injecting—in line with the product—an inert gas, so as to make it more aerated.

The state-of-the-art provides for the production of acid coagulation spreadable cheese in a container. Some products are obtained by discarding whey. Other products are made by maintaining whey (see U.S. Pat. No. 7,897,185B1), but by applying several solutions in the recipe (in particular addition of stabilisers) and possibly in the process (in-line injection of inert gas) so as to obtain a product that is spreadable and not subject to syneresis. The latter phenomenon is to be avoided for a product that can be manufactured at industrial level.

As known, the current market is more and more oriented towards natural products and/or products without additives.

Therefore, for a broad bracket of consumers, there is felt the need for providing a spreadable fresh cheese consisting of a natural product, rich in functional and beneficial components, substantially without additives, which can be consumed always fresh.

To date, such need remains entirely unaddressed.

### SUMMARY OF THE INVENTION

Therefore, the main object of the present invention is to fully or partly eliminate the aforementioned drawbacks of the prior art, by providing an acid coagulated spreadable fresh cheese which maintains—therein—the biological, nutritional, and functional characteristics of whey, and at the same time—which can be consumed always fresh without being subjected to syneresis.

A further object of the present invention is to provide an acid coagulated spreadable fresh cheese which can be packaged so as to optimally maintain the hygiene conditions, and keep the characteristics thereof intact throughout its shelf life without addition preservatives.

A further object of the present invention is to provide an acid coagulated spreadable fresh cheese which—at the time of consumption—has a consistency such to make it spreadable without containing stabilisers.

The technical characteristics of the invention, according to the objects, are clearly observable from the content of the claims outlined below and the advantages thereof will be more apparent from the detailed description that follows.

### DETAILED DESCRIPTION

Forming an object of the present invention is an acid coagulated spreadable fresh cheese and the relative production method.

For the sake description simplicity firstly described below is the method for producing acid coagulated spreadable fresh cheese according to the invention, and then the spreadable fresh cheese subsequently.

According to a general embodiment of the invention, the method for making a spreadable fresh cheese according to the invention sequentially comprises the following operating steps:
a) preparing milk and cream;
b) mixing the cow milk with cream in a ratio such to obtain a liquid mixture having a predefined percentage by weight of fat comprised between 18-40%;
c) pasteurising said liquid mixture;
d) homogenising said liquid mixture at pressure values comprised between 20-300 bar;
e) cooling said pasteurised and homogenised liquid mixture;
f) coagulating said liquid incorporating lactic ferments at temperatures comprised between 20-45° C. and leaving the lactic ferments to act until there is obtained a coagulated liquid having a pH comprised between 4-5.25, said coagulated liquid incorporating the whey protein;
g) pasteurising said coagulated liquid to block the acidifying activity of the lactic ferments;
h) homogenising said coagulated liquid pasteurised at pressure values comprised between 20 and 400 bar until there is obtained an optimal predefined particle size distribution of said coagulated liquid;
i) cooling said pasteurised homogenised coagulated liquid;
j) adding salt and optionally natural flavours and/or natural colorants; and
k) packaging said coagulated liquid in aerosol containers.

The method for producing spreadable fresh cheese according to the invention initially provides for a step b) of mixing milk and cream until it reaches a desired concentration of fat in the finished product comprised between 18-40% by weight. Advantageously, the texture and the palatability of the cheese varies depending on the percentage of fat present in the recipe.

Preferably, said predefined percentage by weight of fat is comprised between 22-30% by weight, even more preferably equal to 28% by weight. Such fat percentage values ensure good performance in terms of texture and palatability.

The milk, preferably skimmed, may be cow, goat, or sheep milk or a mixture thereof.

Operatively, the step c) of pasteurising said milk and cream liquid mixture is carried out so as to prevent such mixture from subsequently leading to contaminations by inherent microorganisms of the initial raw material, avoiding post contaminations in the acidification step due to abnormal fermentations.

Preferably, the step c) of pasteurising said liquid mixture is carried out under standard conditions at a temperature of 72° C. for a period of 20 s.

Operatively, the step d) of homogenising said liquid mixture is aimed at obtaining a predefined particle size distribution of the mixture.

Preferably, the step d) of homogenising said liquid mixture is carried out at pressure values comprised between 100-300 bar, and even more preferably equal to 200 bar.

Preferably, the step e) for cooling said pasteurised and homogenised liquid mixture is carried out until there is reached a predefined temperature which depends on the type of lactic ferments used in the coagulation step f).

In the step f) for coagulating said liquid mixture, the incorporation of the lactic ferments serves to acidify the mixture and confer organoleptic and gustatory structure to the product.

Preferably, the method for producing spreadable fresh cheese provides for the use of lactic ferments, which have an optimal growth temperature comprised between 20-45° C. The choice of the microflora to be used is mainly due to the type of cheese to be made.

Advantageously, there can be used lactic ferments which comprise solely or mainly mesophilic lactic ferments, having an optimal growth temperature comprised between 28-30° C. Such lactic ferments are ideal for the production of spreadable fresh cheese.

Advantageously, there can be used lactic ferments which comprise solely or mainly thermophilic lactic ferments, having an optimal growth temperature comprised between 37-40° C. The use of thermophilic ferments makes the texture of the fresh cheese more still and compact.

Operatively, the pH that should be reached in the coagulating step f) is selected as a function of the degree of spreadability of the product. The consistency/viscosity of the product increases as the pH decreases.

The final pH of the fermented product may vary depending on the flavour intended to be obtained and on the texture of the finished product. For example, pH 4.9 allows to obtain a cheese with a less spreadable texture with respect to a higher pH (i.e., 5.2).

The pasteurisation step g) has the purpose of blocking the acidifying activity of lactic ferments and therefore standardise the finished product so as to ensure the same performance throughout the entire shelf-life.

Preferably, the step g) of pasteurising said coagulated liquid is carried out at temperatures comprised between 72-95° C.

Advantageously, the pasteurisation step g) may be used to increase the viscosity of the product. Operatively, an increase in the pasteurisation temperature corresponds to increase in the viscosity of the product due to a greater reaggregation of the whey proteins denatured during the pasteurisation thermal treatment step.

Preferably, the choice of the pasteurisation temperature is also carried out as a function of the fat percentage of the finished product.

The step h) of homogenising the pasteurised coagulated liquid is aimed at obtaining an optimal particle size distribution so as to stabilise the product.

Advantageously, the homogenisation step h) allows to obtain a particle size distribution of the product that is finer as the pressure values increase. The pressure increase leads to an increase in the respective cooking stress of the emulsion, allowing to obtain a product that more still and less spreadable (i.e. 300 bars) Lower pressure values allow to define the ideal texture of the product, making it softer and more spreadable.

Advantageously, the pressure at which the step h) of homogenising said pasteurised coagulated liquid is carried out is selected as a function of the particle size distribution intended to be obtained in the finished product. As the pressure increases, the particle size distribution moves towards finer values, which confer greater viscosity to the finished product.

Preferably, the homogenisation step h) is carried out so as to obtain a bimodal development of the particle size, characterised by a limited population of casein micelles with a diameter comprised between 0.05-0.5 μm and by a prevalent population of fat globules with an average diameter between 5 -15 μm.

Preferably, in the cooling step i) said coagulated liquid is cooled up to 4° C., so that it can be conveyed to the packaging step.

As highlighted above, the production method comprises a step j) of adding salt and optionally natural flavours and/or natural colorants to the coagulated liquid.

Advantageously, the spreadable fresh cheese according to the invention may therefore be developed in neutral formulation or in flavoured for which with natural extracts.

Advantageously, the method may comprise an optional step l) of adding soluble natural fibres to the milk and cream liquid mixture, preferably prior to the homogenisation step d).

Preferably, the soluble natural fibres are added up to 15% by weight of the dry residue of the product.

In particular, the soluble natural fibres may be selected from the group consisting of Fibres derived from Chicory, Citrus fruits, Potato, Pea. Preferably, soluble natural fibres are added should the fat content be lower than 22%.

The final step of the method for producing spreadable fresh cheese consists in the step k) of packaging said coagulated liquid in aerosol containers.

Preferably, such step k) of packaging said coagulated liquid in aerosol containers comprises the following operating sub-steps:
k1) introducing a predefined amount of coagulated liquid inside at least one aerosol container;
k2) sealing said aerosol container by applying a valve device to the container;
k3) injecting into said aerosol container through said valve device a gas or a gas mixture, comprising at least one propellant gas.

Generally, the aerosol packaging technology is per se known well known and it provides for introducing gas and/or a mixture of gases into the container. The container is then sealed with a valve device (or valve) through which the mixture of gases can be injected. The valve also serves as an ejector for the gas mixed product. The passage of the food product through a dispenser then determines the desired shape.

In greater detail, the apparatus for making an aerosol product are defined by a tubular-shaped container provided with: an outlet section and means for dispensing the compound/product contained in a reservoir (which contains both the food product (the cheese) and the gas (mixture of gases or propellant)); a discharge valve which is normally closed and arranged at the outlet section of the reservoir; a nozzle for ejecting the product contained in the reservoir connected with the discharge valve; a dispenser fluidically connected with the ejection nozzle and provided with an expansion chamber (or a receipt chamber) and an outlet portion of said dispenser which comprises protruding elements spaced from each other and shaped so as to shape the cheese product exiting from the reservoir through the discharge nozzle and the dispenser.

It was observed that under static conditions the coagulated liquid, which—once dispensed—forms the spreadable fresh cheese, packaged in an aerosol container, tends to vascosize creating a thixotropic network which can return to acceptable viscosity values for an aerosol product only if stressed mechanically.

Preferably, for this reason, there may be provided for the insertion—into the aerosol container—of a plurality of beads made of inert material, preferably in a number comprised between 1 and 3, preferably each bead having a diameter comprised between 5 and 15 mm.

Preferably, the step k) of packaging into aerosol containers provides for injecting—into such containers—a mixture of inert gases.

Even more preferably, such mixture of inert gases consists of a mixture of nitrogen protoxide with carbon dioxide or nitrogen.

According to a preferred embodiment of the invention, such mixture of inert gases consists of a mixture of nitrogen protoxide (60-70% by weight) and nitrogen (30-40% by weight).

Preferably, the gas mixture is injected in an amount sufficient to reach a balance pressure at 10° C. of 8 bar and an overrun (volumetric development of the finished product) of the finished product comprised between 250% and 350%.

It was experimentally verified that with the use of the aforementioned gas mixture, according to the aforementioned filling parameters, there were obtained the best results both in terms of consistency and texture of the dispensed product and the time period of absence of syneresis.

No further details are provided given that a person skilled in the art per se already knows this aerosol technology. In particular, such technology is known from the studies dating back to the late 50s last century on propellants used in food products (i.e., spray cream) (Graham, 1958 [History and background of pressurized foods, Food Technol., 12(7), 317]). In particular, in the U.S. Pat. Nos. 2,155,260 and 2,250,300 there is proposed the use of compressed gases such as carbon dioxide and nitrogen protoxide and mixtures thereof (i.e. 85% N₂O+15% CO₂). The use of a mixture of nitrogen protoxide and other inert gases and mixtures thereof was described in the U.S. Pat. Nos. 2,294,172, 2,435,682 and 2,281,604 relating to a butter packaging (aerated butter).

The aforementioned patents are herein fully incorporated as reference.

The product consisting of only the milk cream (preferably cow milk) at a fat concentration comprised between 18-40% by weight, without preservatives and/or stabilisers and/or added texturisers, acidified through lactic ferments and with a pH comprised between 4-5.2, packaged in aerosol containers containing mixtures of propellant gases (in particular as described above), is dispensed in form of whipped fresh cheese having an aerated and still structure, free of syneresis when used immediately, with typical and delicate taste due to the increase in volume caused by the incorporation of gases.

Surprisingly, the combination of the characteristics of the aforementioned product as described above and of the aerosol packaging technology determines a spreadable fresh cheese having a stable structure and consistency after dispensing, although not containing stabilisers and/or texturisers in any manner whatsoever.

Such behaviour is surprising for a person skilled in the art. As a matter of fact, given that the product is in liquid form, when filling the aerosol container, similarly to what happens for a spray cream packaged in aerosol containers, a person skilled in the art would expect to obtain such structure and consistency performance only by adding stabilisers and texturisers (e.g., sugars) into the product to obtain a whipped structure which has a determined consistency, ideal to be consumed within a short period of time. In other words, a person skilled in the art would not expect such behaviour for the spreadable cheese product according to the invention thanks to the aid of the aerosol technology.

Surprisingly, there was instead observed a synergistic effect between the aerosol technology and the spreadable fresh cheese according to the invention, which can most likely be attributed to the fact that the product according to the invention has a matrix entirely different from spray cream, that is this is a milk-based product acidified using microbial starters.

Several factors which may have texturising activity on such matrix—such as pH, homogenisation and process temperature—are involved. Such variables, combined with the aerosol technology, play a major role in the structure of the end product and allow to avoid adding stabilisers and texturisers which are normally essential in other aerosol-packaged food products.

The spray product is formulated so as to be maintained in liquid form inside the pressurised reservoir mentioned above, so as to be instantaneously whipped when dispensing thanks to the presence—in the composition—of at least one gas solubilised in the liquid phase inside the pressurised reservoir; when the spray cheese is dispensed, the pressure difference between the internal and the external of the reservoir causes the expansion of the solubilised gas which guides the product outside the container and through the dispenser (propellant action of the gas) and, at the same time, the expanding gas bubbles are incorporated in the product so as to whip it. The characteristics of the gas mixed in the reservoir together with the cheese product in liquid phase (that is the so-called “overrun” which defines an index for mixing the propellant gas with the product), the percentage of fat present in the product in the reservoir, the temperature of said product and the freshness thereof affect the stiffness or firmness of the dispensed product and, therefore, the quality of the product.

The technological characteristics which—for the product according to the invention—affect its rheological properties are identified in the following parameters: pH, homogenisation, process temperature. Furthermore, the aerosol technology—combined with the optimisation of such product and process parameters—allows to obtain the desired consistency of the dispensed finished product, with a certainly better texture than any food product packaged in aerosol containers without adding stabilisers and texturisers.

Thanks to packaging in aerosol containers, the spreadable fresh cheese according to the invention can be used several times and with hygiene characteristics that are constant over time. This peculiarity is mainly due to the application of the aerosol technology.

### EMBODIMENT EXAMPLE 1

The process started by mixing cow milk with cream, so as to obtain a percentage of fat equal to 28% by weight. Then, the mixture was pasteurised under standard conditions (72° C. for 20 s). The particle size distribution of the mixture was then standardised through a first homogenisation step at a pressure of 200 bar through a piston homogeniser. The liquid mixture was then cooled up to about 28° C.

Mesophilic lactic ferments were subsequently incorporated in the mixture at a temperature comprised between 28-30° C. A 4.8 pH was achieved, obtaining a coagulated liquid. Then the process continued with subjecting said coagulated liquid to a subsequent pasteurisation thermal treatment at a temperature of 85° C. for a period of 15 sec. Subsequently, the pasteurised coagulated liquid was subjected to a second homogenisation step in a two-stage piston homogeniser at a pressure of 200 bar, including 0 bar on the second stage and 200 bar in the first stage, aimed at obtaining an optimal particle size distribution so as to stabilise the product. The particle size analysis has shown a bimodal development, characterised by a limited population of casein micelles with an average diameter comprised between 0.05 and 0.5 μm and by a prevalent population of fat globules with an average diameter between 5 and 15 μm.

The coagulated liquid thus processed was salted, cooled to 4° C. and conveyed to packaging in aerosol containers.

The aerosol packaging provided for using a mixture of nitrogen protoxide (65%) and nitrogen (35%) in amounts sufficient to obtain a balance pressure of 8 bar at 10° C. and a 250% overrun of the finished product.

The fresh cheese thus produced and packaged is dispensed from the aerosol container in form of whipped fresh cheese having an aerated and still structure, free of syneresis when used immediately, with typical and delicate taste due to the increase in volume caused by the incorporation of gases.

Such acid coagulated spreadable fresh cheese had:
a dry residue equal to 37% by weight;
a moisture content equal to 63% by weight.

The composition of the dry residue was as follows:
28% by weight of fats;
2.5% by weight of proteins;
0.35% by weight of salt (NaCl); and carbohydrates for the remainder.

The product had a pH equal to 4.8.

the spreadable cheese is free of stabilisers and/or texturisers.

### EMBODIMENT EXAMPLE 2

The process was carried out like in example 1, except for the changes below.

For the production of a lighter version (with lower fat content) of the spreadable cheese according to the invention, the process started by bar at mixing cow milk with cream, so as to obtain a percentage of fat equal to 18% by weight. An amount of soluble inulin natural fibres (fibres derived from chicory) in the order of 5% by weight, is added to the mixture thus standardised. Then, the mixture was pasteurised under standard conditions (72° C. for 20 s). The particle size distribution of the mixture was then standardised through a first homogenisation step at a pressure of 200 bar. The liquid mixture was then cooled up to about 28° C.

The subsequent process steps follow the embodiment example no 1, only adding a natural salmon flavour when salting.

The fresh cheese thus produced and packaged is dispensed in from the aerosol container in form of whipped fresh cheese having an aerated and still structure, with a 350% overrun, free of syneresis when used immediately, with typical and delicate taste due to the increase in volume caused by the incorporation of gases.

Such acid coagulated spreadable fresh cheese had:
a dry residue equal to 33% by weight; and
a moisture content equal to 67% by weight;

The composition of the dry residue was as follows:
18% by weight of fats;
2.8% by weight of proteins;
5% by weight of inulin natural fibres;
0.35% by weight of salt (NaCl);
0.2% by weight of natural salmon flavour; and
for the remainder of carbohydrates.

The product had a pH equal to 5.

The spreadable cheese is free of stabilisers and/or texturisers.
According to a general embodiment of the invention the acid coagulated spreadable fresh cheese has an acidified milk base particle matrix.

The product has:
a dry residue comprised between 33% and 47% by weight; and
a moisture content comprised between 53% and 67% by weight.

The dry residue consists of:
between 18% and 40% by weight of fats;
between 2% and 2.5% by weight of proteins;
optionally up to 15% by weight of water-soluble natural fibres;
between 0.10 and 0.50% by weight of salt;
optionally between 0.1 and 0.3% by weight of natural flavours and/or natural colorants; and
for the remainder of carbohydrates.

The spreadable fresh cheese according to the invention has a pH comprised between 4 and 5.2.

According to an essential aspect of the present invention, said spreadable cheese is free of stabilisers and/or texturisers.

The expression “stabilisers” is used to indicate additives adapted to improve the stability of the product. Typical stabilisers used in spreadable cheese (and absolutely absent in the spreadable cheese according to the invention) are selected from the group consisting of additives between E339 and E466 (Codex Alimentarius, 2nd edition, 2011). In greater detail, such typical stabilisers may be:
E 339 Sodium phosphates
E 340 Potassium phosphates
E 341 Calcium phosphates
E 343 Magnesium phosphates
E400 Alginic acid
E 401 Sodium alginate
E 402 Potassium alginate
E 403 Ammonium alginate
E 404 Calcium alginate
E 405Propane-1, 2-diol alginate
E 406 Agar-agar
E 407a Processed eucheuma algae
E 407 Carrageenan
E 410 Locust bean flour
E 412 Guar gum
E 413 Tragacanth gum
E 414 Gum arabic (gum acacia)
E 415 Xanthan gum
E 416 Karaya gum
E 417 Tara gum
E 418 Gellan gum
E 450 Diphosphates
E 451 Triphosphates
E 452 Polyphosphates
E 466 Carboxymethyl cellulose sodium, cellulose gum

The expression “texturisers” is used to indicate additives adapted to improve the consistency of the product. Typical texturisers used in spreadable cheese (and absolutely absent in the spreadable cheese according to the invention) are selected from the group consisting of additives between E 1400 and E 1442 (Codex Alimentarius, 2nd edition, 2011). In greater detail, such typical texturisers may be:
E 1404 Oxidised starch
E 1410 Monostarch phosphate
E 1412 Distarch phosphate
E 1413 Phosphated distarch phosphate
E 1414 Acetylated distarch phosphate
E 1420 Acetylated starch
E 1422 Acetylated distarch adipate
E 1440 Hydroxypropyl starch
E 1442 Hydroxypropyl distarch phosphate

According to a further essential aspect of the present invention, the spreadable cheese is packaged in an aerosol container together with at least one propellant gas, and preferably together with a gas mixture.

The spreadable cheese according to the invention is in liquid form at room temperature in said aerosol container and—at the time of dispensing from said aerosol container—it is in form of a whipped product having an aerated, still and spreadable structure free of syneresis when used immediately.

Preferably, the aforementioned cheese has a particle size with bimodal development, defined by a limited population of casein micelles with an average diameter comprised between 0.05-0.5 μm and by a prevalent population of fat globules with an average diameter between 5 and 15 μm.

Preferably, the fat content of said spreadable cheese is comprised between 18 and 30% by weight.

Advantageously, the gas together with which the spreadable cheese is packaged in said aerosol container is a mixture of nitrogen protoxide with carbon dioxide or nitrogen.

According to a preferred embodiment of the invention, such mixture of inert gases consists of a mixture of nitrogen protoxide (60-70% by weight) and nitrogen (30-40% by weight).

Preferably, the gas mixture is injected in an amount sufficient to reach a balance pressure at 10° C. of 8 bar and an overrun (volumetric development of the finished product) of the finished product comprised between 250% and 350%.

Advantageously, said aerosol container in which the spreadable cheese according to the invention is packaged contains several beads made of inert material. Preferably, the number of beads is comprised between 1 and 3, preferably each bead having a diameter comprised between 5 and 15 mm.

Forming an object of the present invention is a packaging for an acid coagulated spreadable fresh cheese, in form of aerosol container. The spreadable fresh cheese contained in such packaging is an acid coagulated spreadable fresh cheese according to the present invention, and in particular as described above.

Preferably, the aerosol container of said packaging is tubular-shaped and it defines a reservoir provided with an outlet section and means for dispensing the product contained in said reservoir.

Preferably, said dispensing means comprise:
a discharge valve which is normally closed and it is arranged at the outlet section of the reservoir,
a nozzle for ejecting the product contained in the reservoir connected to the discharge valve;
a dispenser fluidically connected with the ejection nozzle and provided with an expansion chamber (or receipt chamber) and an outlet portion of said dispenser which comprises protruding elements spaced apart and shaped so as to shape the cheese product exiting from the reservoir through the discharge nozzle and dispenser.

Preferably, the aerosol container of said packaging contains—inside the reservoir—a plurality of beads made of inert material, preferably in a number comprised between 1 and 3, preferably each bead having a diameter comprised between 5 and 15 mm.

The invention allows to obtain numerous advantages, already partly described above.

The acid coagulated spreadable fresh cheese maintains—therein—the biological, nutritional, and functional characteristics of whey, and—at the same time—it can be consumed still fresh without being subjected to syneresis.

The spreadable cheese according invention maintains its nutritional properties because whey was maintained in the recipe contrary to what happens in the standard process flow of spreadable cheese. Such whey component notoriously contains important substances from a functional, nutritional and health point of view.

The spreadable fresh cheese subject of the present invention uses aerosol technology to obtain a product that would otherwise be more liquid when whipped.

The present invention avoids the disposal of the whey by-product by incorporating it into the recipe. The limit given by the fluid consistency of the product due to maintaining whey in the recipe is overcome by the application of aerosol technology, which—thanks to the absorption of gases—allows the dispensing of a spreadable cheese.

Maintaining whey in the recipe also allows to avoid the disposal and recovery step that would normally be expensive and would have a significant energy and environmental impact.

The use of the aerosol technology allows the acid coagulated spreadable fresh cheese according to the invention to be packaged so as to optimally maintain the hygiene conditions, and keep the characteristics thereof intact throughout its shelf life without addition preservatives.

With respect to spreadable fresh cheese currently available on the market, the cheese according to the present invention, packaged in aerosol containers, ensures greater shelf-life without using preservatives and stabilisers.

Surprisingly, using the aerosol technology allows the acid coagulated spreadable fresh cheese according to the invention—at the time of consumption—to have a consistency such to make it spreadable without containing stabilisers.

The spreadable cheese according to the invention is not subject to syneresis, at least as soon as it is dispensed (although some tests seem to confirm the absence of syneresis several hours after dispensing at room temperature (25° C.) given its immediate use, which ensures that it is consumed still fresh as if it had just been opened in a container.

The aerosol packaging technology, avoids to indicate the secondary shelf-life of the product (i.e., “to be consumed within one week from date opening, once opened) and it allows to consume the product still fresh, therefore maintaining the characteristics thereof optimal.

The aerosol containers allow to use the product multiple times until the end of primary shelf-life deadline (i.e., consumption within 4 months) guaranteed by hermiticity.

Since it is packaged in aerosol containers, the spreadable fresh cheese according to the invention is also easy to use (ready-to-use).

In short, the spreadable fresh cheese according to the invention can meet the demands of a market increasingly oriented toward products that are natural and/or without additives (preservatives and stabilisers). As a matter of fact, the spreadable fresh cheese according to the invention is a natural product, rich in functional and beneficial components, which uses the aerosol technology (ready to use) so as to allow the product to be used still fresh, ensuring its shelf-life and use until the end of the primary shelf-life, allowing the consumption of a natural product without adding additives at any time of the day, which would otherwise have been unusable by following a standard packaging process without adding stabilisers.

Therefore, the invention thus conceived attains the pre-set objects.

Obviously, in its practical embodiment, it may take shapes and configurations even different from the ones illustrated above without departing from the present scope of protection.

Furthermore, all details can be replaced by other technically equivalent elements and the dimensions, shapes and materials used may vary depending on the needs.

1. A packaging including an acid coagulated spreadable fresh cheese comprising:
an acidified milk base particle matrix;
a dry residue comprised between 33% and 47% by weight; and
a moisture content comprised between 53% and 67% by weight,
wherein the dry residue consists of:
between 18% and 40% by weight of fats;
between 2% and 2.5% by weight of proteins;
optionally up to 15% by weight of water-soluble natural fibres;
between 0.10 and 0.50% by weight of salt;
optionally between 0.1 and 0.3% by weight of natural flavours and/or natural colorants; and
for the remainder of carbohydrates
being devoid of stabilisers and/or texturisers,
said cheese having a pH comprised between 4 and 5.2;
an aerosol container including said cheese together with at least one propellent gas, said cheese being in liquid form at room temperature in said aerosol container and being—at the time of dispensing from said aerosol container—in form of a whipped product having an aerated, still and spreadable structure free of syneresis when used immediately.

2. The packaging according to claim 1, having a particle size with bimodal development, defined by a limited population of casein micelles with an average diameter comprised between 0.05-0.5 μm and by a prevalent population of fat globules with an average diameter between 5 -15 μm.

3. The packaging according to claim 1, wherein said fat content is comprised between 22-30% by weight.

4. The packaging according to claim 1, wherein the gas together with which it is packaged in said aerosol container is a mixture of inert gases consisting of nitrogen protoxide mixed with carbon dioxide or nitrogen.

5. The packaging according to claim 1, wherein the gas mixture is in an amount sufficient to reach a balance pressure at 10° C. of 8 bar and the index for mixing the gas with the product inside said aerosol container is comprised between 250% and 350%.

6. The packaging according to claim 1, wherein said aerosol container contains a plurality of beads made of inert material.

7. (canceled)

8. The packaging according to claim 1, wherein said aerosol container is tubular-shaped and defines a reservoir provided with an outlet section and a discharge valve which is normally closed and arranged at the outlet section of the reservoir; a nozzle for ejecting the product contained in the reservoir connected with the discharge valve; a dispenser fluidically connected with the ejection nozzle and provided with an expansion chamber or a receipt chamber and an outlet portion of said dispenser which comprises protruding elements spaced from each other and shaped so as to shape the cheese product exiting from the reservoir through the discharge nozzle and the dispenser.

9. The packaging according to claim 7, wherein said aerosol container contains a plurality of beads made of inert material.

10. A method for making a spreadable fresh cheese, sequentially comprising the following operating steps:
a) preparing milk and cream;
b) mixing the milk with cream in a ratio such to obtain a liquid mixture having a predefined percentage by weight of fat comprised between 18-40%;
c) pasteurising said liquid mixture;
d) homogenising said liquid mixture at pressure values comprised between 20-300 bar;
e) cooling said pasteurised and homogenised liquid mixture;
f) coagulating said liquid mixture, incorporating lactic ferments at temperatures comprised between 20-45° C. and leaving the lactic ferments to act until there is obtained a coagulated liquid having a pH comprised between 4-5.25, said coagulated liquid incorporating the whey protein;
g) pasteurising said coagulated liquid to block the acidifying activity of the lactic ferments;
h) homogenising said coagulated liquid pasteurised at pressure values comprised between 20 and 400 bar until there is obtained an optimal predefined particle size distribution of said coagulated liquid;
i) cooling said pasteurised homogenised coagulated liquid;
j) adding salt and/optionally natural flavours or natural colorants; and
k) packaging said coagulated liquid in aerosol containers.

11. The method according to claim 10, wherein said predefined percentage by weight of fat is comprised between 22-30%.

12. The method according to claim 10, wherein the step c) of pasteurising said liquid mixture is carried out under standard conditions at a temperature of 72° C. for a period of 20 s.

13. The method according to claim 10, wherein the step d) for homogenising said liquid mixture is carried out at pressure values comprised between 100-300 bar.

14. The method according to claim 10, wherein the step e) for cooling said pasteurised and homogenised liquid mixture is carried out until there is reached a predefined temperature which depends on the type of lactic ferments used in the coagulation step f).

15. The method according to claim 10, wherein the lactic ferments used solely or predominantly comprise mesophilic lactic ferments, having an optimal growth temperature comprised between 28-30° C.

16. The method according to claim 10, wherein the lactic ferments used solely or predominantly comprise thermophilic lactic ferments, having an optimal growth temperature comprised between 37-40° C.

17. The method according to claim 10, wherein the pH that should be reached in the coagulation step f) is selected as a function of the degree of spreadability of the product, wherein the consistency/viscosity of the product increases as the pH decreases.

18. The method according to claim 10, wherein the step g) of pasteurising said coagulated liquid is carried out at temperatures comprised between 72-95° C., wherein an increase in the viscosity of the product corresponds to an increase in the pasteurisation temperature due to a greater reaggregation of the whey proteins denatured during the pasteurisation thermal treatment step, preferably the choice of the temperature being carried out also as a function of the percentage of fat of the finished product.

19. The method according to claim 10, wherein the pressure at which the step h) for homogenising said pasteurised coagulated liquid is carried out is selected as a function of the particle size distribution intended to be obtained in the finished product, wherein the particle size distribution moves towards finer values as the pressure increases, which confers a greater viscosity to the finished product.

20. The method according to claim 10, wherein the homogenisation step h) is carried out so as to obtain a bimodal development of the particle size, characterised by a limited population of casein micelles with a diameter comprised between 0.05-0.5 μm and by a prevalent population of fat globules with an average diameter between 5 -15 μm.

21. The method according to claim 10, wherein in the cooling step i) said coagulated liquid is cooled up to 4° C.

22. The method according to claim 10, wherein the step k) for packaging said coagulated liquid in aerosol containers comprises the following operating sub-steps:
k1) introducing a predefined amount of coagulated liquid inside at least one aerosol container;
k2) sealing said aerosol container by applying a valve device to the at least one aerosol container;
k3) injecting into said at least one aerosol container through said valve device a gas or a gas mixture, comprising at least one propellant gas.

23. The method according to claim 10, wherein there is provided for the insertion-into the aerosol container—of a plurality of beads made of inert material.

24. The method according to claim 10, wherein the step k) for packaging in aerosol containers provides for injecting—into such containers—a mixture of inert gases, wherein such mixture of inert gases comprises a mixture of nitrogen protoxide with carbon dioxide or nitrogen.

25. The method according to claim 24, wherein the gas mixture is injected in an amount sufficient to reach a balance pressure at 10° C. of 8 bar and an overrun of the finished product comprised between 250% and 350%.

26. The method according to claim 10. wherein the milk, is cow, goat, or sheep milk, or a mixture thereof.

27. The method according to claim 10, comprising an optional step 1) of adding soluble natural fibres to the milk and cream liquid mixture, preferably before the homogenisation step d), preferably the soluble natural fibres being added up to 15% by weight of the dry residue of the product.

28. The method according to claim 10 characterised in that it is a method for making a packaging for a spreadable cheese according to claim 1.
